(19) United States
(12) Patent Application Publication
(10) Pub. No.: US 2015/0008601 A1
(43) Pub. Date: Jan. 8, 2015

(54) RETARDATION PLATE MANUFACTURING METHOD

(71) Applicant: ARISAWA MFG. CO., LTD., Niigata (JP)

(72) Inventors: Yuichi KAKUBARI, Niigata (JP); Kenichi WATABE, Niigata (JP)

(21) Appl. No.: 14/492,076

(22) Filed: Sep. 22, 2014

Related U.S. Application Data
(63) Continuation of application No. PCT/JP2013/001164, filed on Feb. 27, 2013.

(30) Foreign Application Priority Data
Mar. 26, 2012 (JP) 2012-070153

(51) Int. Cl. G02B 5/30; B29D 11/00; B29C 59/16

(52) U.S. Cl. CPC G02B 5/3083; B29C 59/16; B29D 11/00644; B29L 2011/0066
USPC 264/1.34

(57) ABSTRACT

A retardation plate manufacturing method for manufacturing a retardation plate that has an orientation pattern in which is formed a plurality of regions having optical axes oriented in different directions from each other, the retardation plate manufacturing method comprising arranging an unoriented light orientation layer that is to be oriented by light on a first surface of a substrate; preparing a retardation mask including an orientation pattern in which is formed a plurality of regions that have a quarter wavelength retardation plate retardation function and correspond to the plurality of regions in the orientation pattern of the retardation plate; and orienting the light orientation layer by irradiating the retardation mask with elliptically polarized light and irradiating the light orientation layer with polarized light emitted form the retardation mask.

The contents of the following Japanese patent application and PCT application are incorporated herein by reference:
NO. 2012-070153 filed on Mar. 26, 2012, and
NO. PCT/JP2013/001164 filed on Feb. 27, 2013.

### BACKGROUND

1. Technical Field

The present invention relates to a retardation plate manufacturing method.

2.Related Art

Technology is known that includes radiating linearly polarized light onto a mask having a plurality of regions formed with different orientation directions, to form an optical component having an orientation pattern with a plurality of regions that have different orientation directions from each other, as shown in Patent Document 1, for example.

Patent Document 1: Japanese Patent Application Publication No. H9-33914

However, due to the angle between the polarization direction of the radiated linearly polarized light and the orientation direction of the regions in the mask, the rate of degradation differs among the regions. As a result, there is a problem of variation in the amount of scattering of orientation among the plurality of regions of the optical component.

### SUMMARY

According to a first aspect of the present invention, provided is a retardation plate manufacturing method for manufacturing a retardation plate that has an orientation pattern in which is formed a plurality of regions having optical axes oriented in different directions from each other, the retardation plate manufacturing method comprising arranging an unoriented light orientation layer that is to be oriented by light on a first surface of a substrate; preparing a retardation mask including an orientation pattern in which is formed a plurality of regions that have a quarter wavelength retardation plate retardation function and correspond to the plurality of regions in the orientation pattern of the retardation plate; and orienting the light orientation layer by irradiating the retardation mask with elliptically polarized light and irradiating the light orientation layer with polarized light emitted form the retardation mask.

According to a second aspect of the present invention, provided is a retardation plate manufacturing method for manufacturing a retardation plate that has repetitions of an orientation pattern in which is formed a plurality of regions having optical axes oriented in different directions from each other, the retardation plate manufacturing method comprising arranging an unoriented light orientation layer that is to be oriented by light on a first surface of a substrate; preparing a retardation mask including a plurality of retardation plates that are arranged and each have an orientation pattern in which is formed a plurality of regions corresponding to at least a portion of the plurality of regions in the orientation patterns of the retardation plate; and orienting the light orientation layer by irradiating the retardation mask with polarized light and irradiating the light orientation layer with polarized light emitted form the retardation mask.

The summary clause does not necessarily describe all necessary features of the embodiments of the present invention. The present invention may also be a sub-combination of the features described above.

### BRIEF DESCRIPTION OF THE DRAWINGS

FIG. 1 is a planar view of an entire retardation plate 100 manufactured according to the manufacturing method of the present embodiment.

FIG. 2 is a vertical cross-sectional view along the line II-II in FIG. 1.

FIG. 3 shows the configuration of the entire retardation plate manufacturing apparatus 10 according to the present embodiment.

FIG. 4 is a perspective view of the overall exposing section 18.

FIG. 5 is a vertical cross-sectional view of the retardation mask 38.

FIG. 6 is a perspective view describing the exposure of the film 90 by the mask board 58 of the retardation mask 38.

FIG. 7 is a graph indicating the relationship between degradation of the mask boards 58 and cumulative irradiation energy.

FIG. 8 is a graph indicating the relationship between degradation of the mask boards 58 and cumulative irradiation energy.

FIG. 9 is a cross-sectional view of the altered retardation mask 38.

FIG. 10 is a graph showing the relationship between degradation of the mask board 58 having the protective film 64 formed thereon and the cumulative irradiation energy.

FIG. 11 is a planar view for describing the orientation pattern 306 of the retardation plate 300 oriented by the altered retardation mask 338.

FIG. 12 is a vertical cross-sectional view of he mask member 370 and the mask member 372 of the retardation mask 338.

FIG. 13 shows the relationship between the film 90 and the exploded perspective view of the retardation mask 338.

FIG. 14 is a planar view of the altered retardation mask 438.

FIG. 15 is a view for described an embodiment in which the mask members 370 and 372 are altered.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

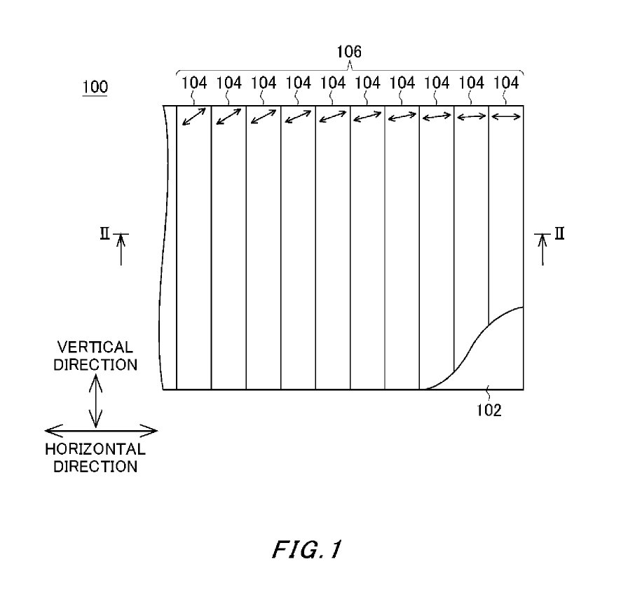

FIG. 1 is a planar view of an entire retardation plate 100 manufactured according to the manufacturing method of the present embodiment. The vertical and horizontal directions indicated by the arrows in FIG. 1 indicate the vertical and horizontal directions of the retardation plate 100.

The retardation plate 100 is provided as a portion of a diffraction grating of an optical low-pass filter, for example. The retardation plate 100 is formed as a rectangle, in which one edge has a length from tens of centimeters to several meters. As shown in FIG. 1, the retardation plate 100 includes a resin substrate 102 and an orientation pattern 106.

The resin substrate 102 is formed by cleaving an elongated resin film, which is described further below, to be a prescribed length. The resin substrate 102 is transparent to light. The thickness of the resin substrate 102 is from 50 μm to 100 μm, for example. The resin substrate 102 supports the orientation pattern 106.

The resin substrate 102 can be formed by a cycloolefin type film. The cycloolefin type film can be a cycloolefin polymer (COP), but is more preferably a cycloolefin copolymer (COC), which is a mixed polymer of cycloolefin polymer. The COP film can be Zeonor film ZF 14 manufactured by ZEON CORPORATION, for example. The resin substrate 102 may be formed by a material including triacetylcellulose (TAC). The TAC film can be Fujitac T80SZ and TD80UL manufactured by FUJIFILM Corporation, for example. When using a cycloolefin type film, it is preferable to use a film with high toughness, in consideration of fragility.

The orientation pattern 106 is formed on one surface of the resin substrate 102. A plurality of retardation regions 104 are formed in the orientation pattern 106. The retardation regions 104 are formed with the same shape, when seen in a planar view. Each retardation region 104 has a rectangular shape with a length extending along the vertical direction of the resin substrate 102. The retardation regions 104 are arranged along the horizontal direction, and the edges of the retardation regions 104 in the vertical direction contact each other. Instead, each retardation region 104 may have a rectangular shape with its length extending along the horizontal direction of the resin substrate 102, and the retardation regions 104 may be arranged along the vertical direction.

The retardation regions 104 modulate the polarization state of polarized light passing therethrough. The retardation regions 104 have the retardation function of a half wavelength retardation plate, for example. Instead, the retardation regions 104 may have the retardation function of a quarter wavelength retardation plate. The following description deals with a case in which the retardation regions 104 have the retardation function of a half wavelength retardation plate.

The retardation regions 104 have optical axes in the directions indicated by the arrows at the top ends of the retardation regions 104 in FIG. 1. These optical axes are fast axes or slow axes. The retardation regions 104 have optical axes oriented in different directions from each other.

The differences in angle of the optical axes between a retardation region 104 and an adjacent retardation region 104 are uniform. For example, this angular difference of the optical axis may be 2.81°. Accordingly, as shown in FIG. 1, when the retardation region 104 at the right end has an optical axis in the horizontal direction, the optical axis of the retardation region 104 that is second from the right end is inclined by 2.81° relative to the horizontal direction. Furthermore, the optical axis of the retardation region 104 that is n-th from the right end is inclined by 2.81 ×(n−1)° relative to the horizontal direction. The optical axes of the retardation regions 104 may all be different directions, or there may be regions where some of the retardation regions 104 have optical axes oriented in the same direction.

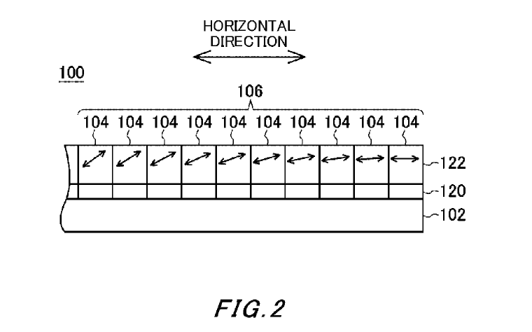

FIG. 2 is a vertical cross-sectional view along the line II-II in FIG. 1. As shown in FIG. 2, the retardation regions 104 include a liquid crystal film 122 and an orientation film 120, which is an example of a light orientation layer. The arrows shown in the retardation regions 104 of FIG. 2 indicate the directions of the optical axes of the retardation regions 104 as seen from a planar view.

The orientation film 120 is formed on the surface of the resin substrate 102. The orientation film 120 can adopt a light orienting compound. The light orienting compound is a material that, when irradiated with linearly polarized light such as ultraviolet light, orients the molecules regularly in the polarization direction of this linearly polarized light. Furthermore, the light orienting compound has a function to align the molecules of the liquid crystal film 122 formed thereon to have the same orientation as the light orienting compound. The light orienting compound can be a photolytic, photodimerization, or photoisomerization type compound, for example. The molecules of the orientation film 120 are oriented in a direction corresponding to the optical axes of the retardation regions 104.

The liquid crystal film 122 is formed on the orientation film 120. The liquid crystal film 122 is a liquid crystal polymer that can be cured by heat or ultraviolet light, for example. The liquid crystal film 122 is oriented in the same manner as the orientation film 120.

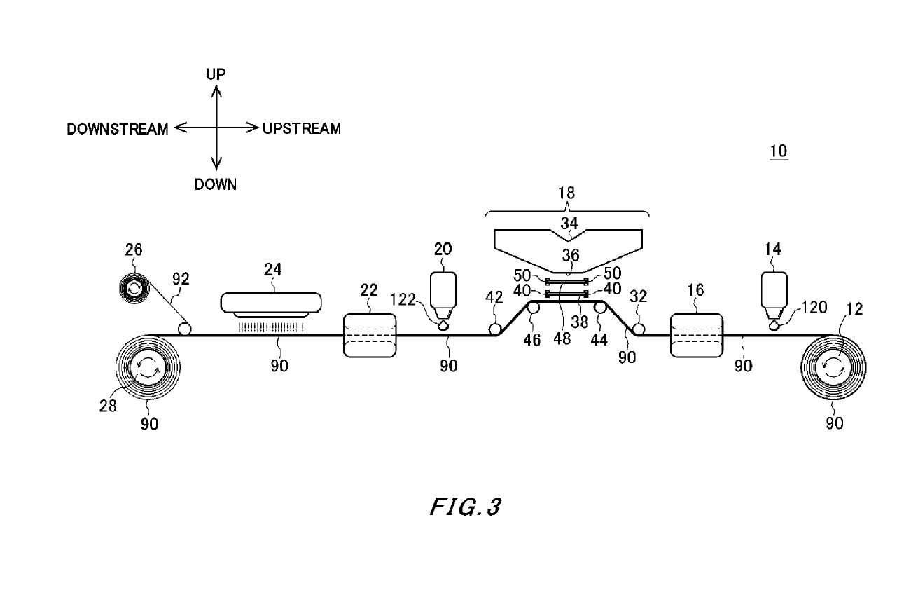

FIG. 3 shows the configuration of the entire retardation plate manufacturing apparatus 10 according to the present embodiment. The up and down directions indicated by the arrows in FIG. 3 represent the up and down directions of the retardation plate manufacturing apparatus 10. Furthermore, “upstream” and “downstream” refer to upstream and downstream positions in the transport direction. The transport direction is a direction parallel to the vertical direction of the retardation plate 100 and the longitudinal direction of the film 90, and orthogonal to the horizontal direction of the retardation plate 100 and the arrangement direction of the retardation regions 104.

As shown in FIG. 3, the retardation plate manufacturing apparatus 10 includes a feeding roller 12, an orientation film applying section 14, an orientation film drying section 16, an exposing section 18, a liquid crystal film applying section 20, a liquid crystal film orienting section 22, a liquid crystal film curing section 24, a separation film supplying section 26, and a winding roller 28.

The feeding roller 12 is arranged farthest upstream in the transport path of the film 90. The film 90 to be supplied is wound around the outside of the feeding roller 12. The film 90 to be supplied is the same material as the resin substrate 102. The feeding roller 12 is supported in a manner to enable rotation. In this way, the feeding roller 12 can hold the film 90 in a manner to enable feeding of the film 90. The feeding roller 12 may be able to rotate due to a drive mechanism such as a motor, or may be capable of following the rotation of the winding roller 28. As another example, a mechanism for transporting the film 90 may be provided within the transport path.

The orientation film applying section 14 is downstream of the feeding roller 12, and is arranged above the transport path of the film 90 being transported. The orientation film applying section 14 applies the orientation film 120 in a liquid and unoriented state on the top surface of the film 90.

The orientation film drying section 16 is arranged downstream from the orientation film applying section 14. The orientation film drying section 16 dries the orientation film 120 applied on the film 90 passing therethrough, using heat, light radiation, or wind.

The exposing section 18 is arranged downstream from the orientation film drying section 16. The exposing section 18 includes an upstream following roller 32, a polarized light source 34, a circularly polarized light modulating section 48, a circularly polarized light modulation holding section 50, a retardation mask 38, a mask holding section 40, a downstream following roller 42, and an upstream tension roller 44 and downstream tension roller 46 forming a pair. The exposing section 18 irradiates the orientation film 120 applied on the film 90 with polarized light output from the outlet 36 of the polarized light source 34, through the circularly polarized light modulating section 48 and the retardation mask 38. In this way, the exposing section 18 orients the orientation film 120 and forms a pattern. The polarized light output from the polarized light source 34 is ultraviolet light with a wavelength from 280 nm to 340 nm, for example.

The liquid crystal film applying section 20 is arranged downstream from the exposing section 18. The liquid crystal film applying section 20 is arranged above the transport path of the film 90. The liquid crystal film applying section 20 applies the liquid crystal film 122 on the orientation film 120 formed on the film 90.

The liquid crystal film orienting section 22 is arranged downstream from the liquid crystal film applying section 20. The liquid crystal film orienting section 22 dries the liquid crystal film 122 formed on the orientation film 120 passing therethrough, using heat, light radiation, or wind. In this case, the liquid crystal film 122 is automatically oriented to have the orientation direction of the orientation film 120.

The liquid crystal film curing section 24 is arranged downstream from the liquid crystal film orienting section 22. The liquid crystal film curing section 24 cures the liquid crystal film 122 by irradiating the liquid crystal film 122 with ultraviolet light. In this way, the orientation of the molecules of the liquid crystal film 122, which are oriented in alignment with the orientation of the orientation film 120, is fixed.

The separation film supplying section 26 is arranged between the liquid crystal film curing section 24 and the winding roller 28. The separation film supplying section 26 supplies and attaches the separation film 92 on the liquid crystal film 122 of the film 90. The separation film 92 facilitates separation between the layers of the wound film 90. The separation film supplying section 26 may be omitted.

The winding roller 28 is downstream from the liquid crystal film curing section 24, and is arranged farthest downstream in the transport path. The winding roller 28 is supported in a manner to enable rotational driving. The winding roller 28 minds the film 90 that is patterned by having the orientation film 120 and liquid crystal film 122 formed thereon. In this way, the winding roller 28 transports the film 90 having the orientation film 120 and liquid crystal film 122 formed thereon in the transport direction.

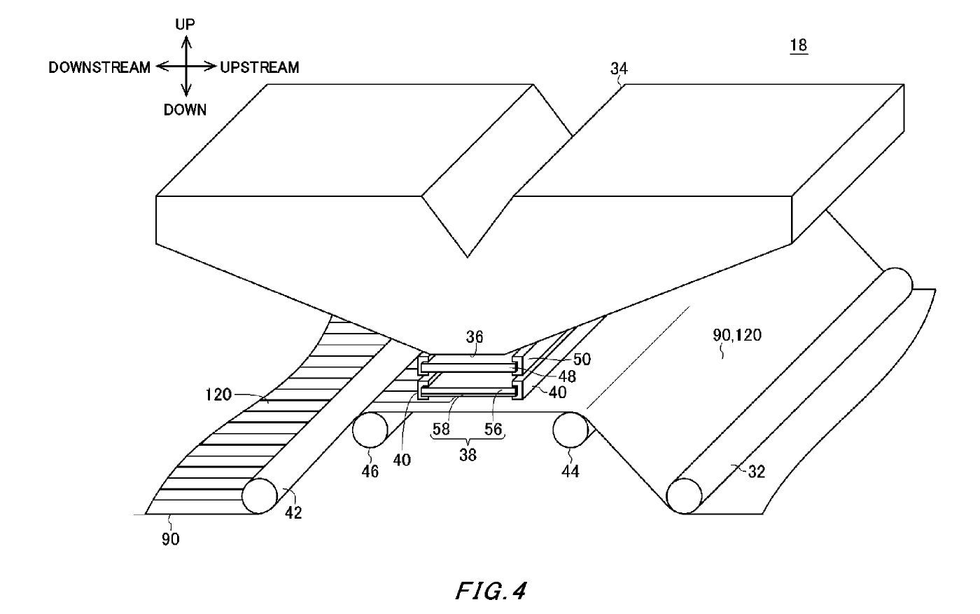

FIG. 4 is a perspective view of the overall exposing section 18. As shown in FIG. 4, the upstream following roller 32 is arranged downstream from the orientation film drying section 16 and upstream from the upstream tension roller 44. The upstream following roller 32 is arranged above the transport path of the film 90. The upstream following roller 32 rotates according to the film 90 transported therebelow. The upstream following roller 32 presses the film 90 downward during transport.

The polarized light source 34 is arranged above the transport path of the film 90. The outlet 36 of the polarized light source 34 through which the polarized light is output is arranged between the upstream tension roller 44 and the downstream tension roller 46. The polarized light source 34 outputs linearly polarized light to the film 90 positioned below the polarized light source 34.

The circularly polarized light modulating section 48 is arranged between the polarized light source 34 and the retardation mask 38. The circularly polarized light modulating section 48 is a quarter wavelength retardation plate, for example. The optical axis of the circularly polarized light modulating section 48 is inclined 45° relative to the polarization direction of the linearly polarized light output from the polarized light source 34, when seen from a planar view. In this way, the circularly polarized light modulating section 48 modulates the linearly polarized ultraviolet light output from the polarized light source 34 to form circularly polarized ultraviolet light, and outputs this circularly polarized light to the retardation mask 38. The light need not be perfectly circularly polarized, and may instead be elliptically polarized light.

The circularly polarized light modulation holding section 50 is held in a manner to be movable in a width direction, which is orthogonal to the transport direction, relative to the film 90. The circularly polarized light modulation holding section 50 holds the circularly polarized light modulating section 48. In this way, the circularly polarized light modulating section 48 can move together with the circularly polarized light modulation holding section 50, by using a motor or actuator, for example.

The retardation mask 38 modulates the circularly polarized light output from the circularly polarized light modulating section 48 to form linearly polarized light having different optical axes, and outputs this linearly polarized light. In this way, the plurality of regions of the film 90 are exposed to the prescribed orientation pattern. The retardation mask 38 is arranged between the circularly polarized light modulating section 48 and the film 90. For example, the retardation mask 38 is arranged several hundred micrometers above the film 90. The retardation mask 38 includes a mask substrate 56 and a mask board 58. The mask substrate 56 is formed from a glass substrate that is transparent to light. The mask substrate 56 holds the mask board 58, and maintains the shape of the mask board 58.

The mask holding section 40 is held in a manner to be movable in the width direction, which is orthogonal to the transport direction, relative to the film 90. The mask holding section 40 holds the retardation mask 38. In this way, the retardation mask 38 can move together with the mask holding section 40, by using a motor or actuator, for example.

The downstream following roller 42 is arranged downstream from the downstream tension roller 46. The downstream following roller 42 is arranged above the transport path of the film 90. The downstream following roller 42 rotates in accordance with the film 90 transported therebelow. The downstream following roller 42 presses the film 90 downward during transport.

The upstream tension roller 44 is arranged upstream from the polarized light source 34 and the retardation mask 38, and downstream from the upstream following roller 32. The downstream tension roller 46 is arranged downstream from the polarized light source 34 and the retardation mask 38, and upstream from the downstream following roller 42. The upstream tension roller 44 and the downstream tension roller 46 are supported in a manner to enable rotation. The upstream tension roller 44 and the downstream tension roller 46 may be rotatable by a drive motor or the like, or may be capable of following the winding roller 28 due to the drive force of the roller 28, for example.

The upstream tension roller 44 and the downstream tension roller 46 are arranged under the transport path. In this way, the upstream tension roller 44 and the downstream tension roller 46 contact and press the bottom surface of the film 90, which is the surface of the film 90 on which the orientation film 120 is not formed. As described above, the film 90 is pressed downward by the upstream following roller 32 and the downstream following roller 42. Accordingly, the upstream tension roller 44 and the downstream tension roller 46 provide a tensile force in the transport direction to the film 90 being pressed downward.

The upstream tension roller 44 and the downstream tension roller 46 are arranged to sandwich the retardation mask 38. The upstream tension roller 44 is arranged farther upstream than the upstream end of the retardation mask 38, and the downstream tension roller 46 is arranged farther downstream than the downstream end of the retardation mask 38. In this way, after the linearly polarized light output from the polarized light source 34 has passed through the film 90, the light is reflected by the upstream tension roller 44 and the downstream tension roller 46 such that the exposure of the film 90 to this light is decreased. The distance between the upstream tension roller 44 and the downstream tension roller 46 can be less than the length of the retardation plate 100 in the longitudinal direction, which is at least several centimeters, provided for a general liquid crystal display. In this way, sufficient tensile force in the transport direction can be provided to the film 90 between the upstream tension roller 44 and the downstream tension roller 46.

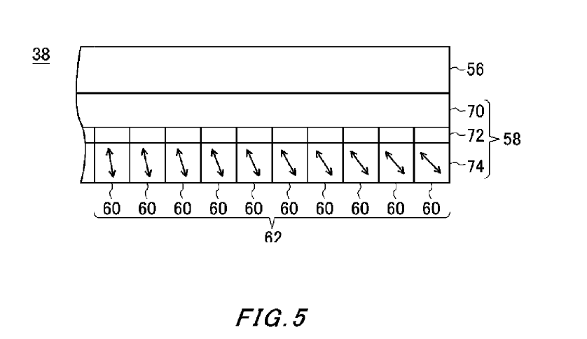

FIG. 5 is a vertical cross-sectional view of the retardation mask 38. The arrows shown in the retardation regions 60 of FIG. 5 indicate the direction of the optical axes of the retardation regions 60, when seen from a planar view. As shown in FIG. 5, the mask board 58 includes a mask pattern 62 and a resin substrate 70 holding the mask pattern 62. The mask pattern 62 is an example of an orientation pattern of the retardation mask. Here, an adhesive layer or refractive index adjusting layer is provided between the mask substrate 56 and the resin substrate 70 of the mask board 58. The refractive index of the refractive index adjusting layer or the adhesive layer is preferably a value between the refractive index of the mask substrate 56 and the refractive index of the resin substrate 70. The refractive index of the mask substrate 56 made from glass is from 1.45 to 1.55, for example. The refractive index of the resin substrate 70 is 1.53 when formed using COP, and is from 1.48 to 1.49 when formed using TAC. When the refractive index adjusting layer is provided between the mask substrate 56 and the resin substrate 70 of the mask board 58, the outer circumference of the mask board 58 is held to the mask substrate 56 by tape.

The mask pattern 62 has a plurality of retardation regions 60 formed corresponding to the plurality of retardation regions 104 of the orientation pattern 106 of the retardation plate 100. The retardation region 60 has the retardation function of a quarter wavelength retardation plate, for example. The retardation regions 60 are arranged in a direction orthogonal to the transport direction. The retardation regions 60 have the same widths as the retardation regions 104 of the retardation plate 100. Here, “width” refers to length in the direction orthogonal to the transport direction. The retardation regions 60 have optical axes in different directions than each other. The angle difference of the optical axes between adjacent retardation regions 60 is equal to the angle difference of the optical axes between adjacent retardation regions 104 of the retardation plate 100. For example, in a case of manufacturing in which the angle difference of the optical axes between adjacent retardation regions 104 of the retardation plate 100 is 2.81°, the angle difference of the optical axes between adjacent retardation regions 60 is also 2.81°. The retardation regions 60 have a liquid crystal film 74 and an orientation film 72 that are layered on one surface of the resin substrate 70. In a state where the liquid crystal film 74 is arranged on the film 90 side where the orientation film 120 is applied, the retardation mask 38 is supported by the mask holding section 40.

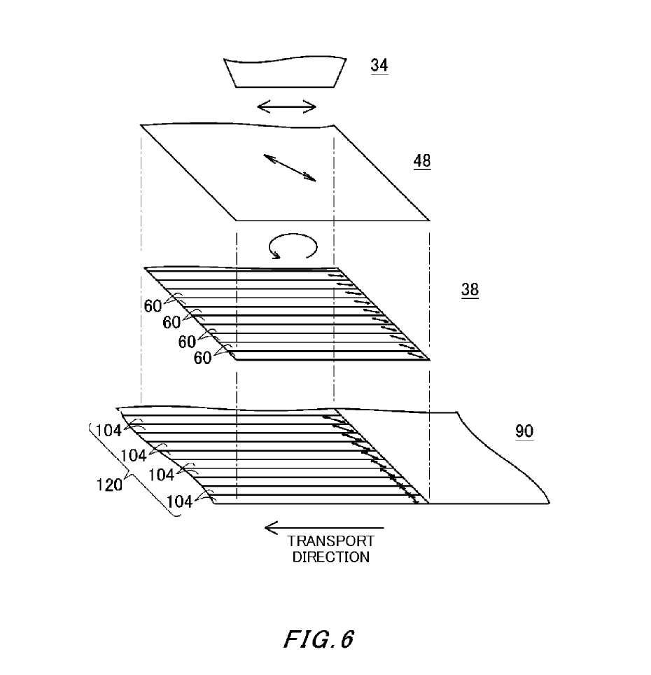

FIG. 6 is a perspective view describing the exposure of the film 90 by the mask board 58 of the retardation mask 38. As shown in FIG. 6, when exposing the film 90, the polarized light source 34 outputs linearly polarized light. The linearly polarized light is modulated to be circularly polarized light by the circularly polarized light modulating section 48, and this circularly polarized light is output. The circularly polarized light is modulated into linearly polarized light by the mask board 58, and this linearly polarized light is output.

Here, the retardation regions 60 of the mask board 58 each have different optical axes, and therefore the polarization direction of the linearly polarized light output from each retardation region 60 differs according to the optical axis thereof In a case where the angle difference in the optical axes between adjacent retardation regions 60 is 2.81°, when the circularly polarized light is input, the angle difference in the polarization directions of the linearly polarized light output from adjacent retardation region 60 is also 2.81°.

The linearly polarized light output from the retardation regions 60 orients the orientation film 120 applied to the film 90 with the same width as the retardation regions 60 from which the linearly polarized light is output, thereby forming the orientation film 120 of the retardation regions 104. The angle difference between the optical axes of the retardation regions 60 and the optical axes of the corresponding retardation regions 104 is 45°. This is because the retardation regions 60 output linearly polarized light with a polarization direction rotated by 45° from the optical axis of the circularly polarized light.

The following describes the retardation plate 100 manufacturing method. First, the elongated film 90 to be wound around the feeding roller 12 is prepared. Here, the total length of the film 90 is approximately 1000 m, for example. The width of the film 90 is approximately 1 m, for example. After this, one end of the film 90 is fixed to the feeding roller 28. In this state, the film 90 is arranged across the top surfaces of the upstream tension roller 44 and the downstream tension roller 46. The retardation mask 38 is prepared, and is held by the mask holding section 40.

Next, the rotational driving of the winding roller 28 is begun. As a result, the film 90 is fed from the feeding roller 12, and is transported along the transport direction.

The fed film 90 passes under the orientation film applying section 14. In this way, the orientation film applying section 14 applies the unoriented orientation film 120 over substantially the entire region of the top surface of the film 90 in the width direction. The application of the orientation film 120 is performed continuously during the transport of the film 90. The orientation film 120 is applied continuously on the top surface across the entire length of the film 90 in the transport direction, aside from portions at the ends.

The film 90 on which the orientation film 120 is applied is transported and passes through the inside of the orientation film drying section 16. In this way, the orientation film 120 applied on the top surface of the film 90 is dried. After this, the film 90 passes under the upstream following roller 32 and over the top surface of the upstream tension roller 44.

When the film 90 with the orientation film 120 applied thereon passes below the polarized light source 34, as described in FIG. 6, the retardation mask 38 is irradiated with circularly polarized light from the polarized light source 34, and the orientation film 120 is irradiated with linearly polarized light emitted from the retardation mask 38. As a result, the orientation film 120 is formed with a plurality of regions whose optical axes are oriented in different directions corresponding to the optical axes of the retardation regions 60 of the mask board 58.

After this, the film 90 having the exposed orientation film 120 passes below the downstream following roller 42 and reaches a position below the liquid crystal film applying section 20. In this way, the liquid crystal film 122 is applied to the top surface of the orientation film 120. Here, the amount of the liquid crystal film 122 applied is adjusted according to the desired retardation of the retardation plate 100. In other words, the amount of the liquid crystal film 122 applied differs between a case in which the retardation regions 104 of the completed retardation plate 100 are to have the retardation function of a quarter wavelength retardation plate and a case in which the retardation regions 104 of the completed retardation plate 100 are to have the retardation function of a half wavelength retardation plate. Furthermore, by changing the amount of the liquid crystal film 122 applied during transport, a portion of the film 90 in the transport direction can be provided with the retardation function of a quarter wavelength retardation plate while the remaining portion can be provided with the retardation function of a half wavelength retardation plate. Since the liquid crystal film 122 is continuously applied to the top surface of the orientation film 120 of the film 90 during transport, the liquid crystal film 122 is applied over the entire length of the film 90 in the transport direction.

After this, the film 90 with the liquid crystal film 122 applied thereon is transported and passes through the liquid crystal film orienting section 22. In this way, the liquid crystal film 122 is heated by the liquid crystal film orienting section 22, and therefore the molecules of the liquid crystal film 122 are oriented in alignment with the orientation of the orientation film 120 formed on the bottom surface thereof, and then dried. As a result, a plurality of retardation regions 104 having different optical axes are formed on the film 90.

Next, the film 90 on which the applied liquid crystal film 122 has been oriented passes through the liquid crystal film curing section 24. In this way, the liquid crystal film 122 is irradiated with ultraviolet light, thereby curing the liquid crystal film 122 in a state where the molecules of the liquid crystal film 122 are oriented in alignment with the optical axes of the orientation film 120. As a result, as shown in FIGS. 1 and 2, the retardation regions 104 formed by the orientation film 120 and the liquid crystal film 122 are arranged and formed in the width direction of the film 90. Next, the separation film 92 is supplied and attached to the top surface of the liquid crystal film 122. The film 90 attached to the top surface of the separation film 92 is wound by the winding roller 28.

After this, until the supply of the film 90 wound on the feeding roller 12 ends, the film 90 is transported by the winding roller 28 and exposure of the film 90 continues. When all of the film 90 wound on the feeding roller 12 has been supplied, the retardation plate 100 manufacturing process ends. The rear end of the finished film 90 may be connected to the front end of a subsequent new film 90, to perform continuous film 90 exposure. Finally, the film 90 is cleaved to be a prescribed length, thereby completing the retardation plate 100 shown in FIGS. 1 and 2.

With the retardation plate manufacturing method of the present embodiment, circularly polarized light is input to the mask board 58 provided to the retardation mask 38. On the other hand, when linearly polarized light is input to the mask board 58, the amount of degradation in each retardation region 60 is different due to the relationship between the polarization direction of the linearly polarized light and the direction of the optical axes of the retardation regions 60 of the mask board 58. Accordingly, the retardation plate 100 manufactured by inputting linearly polarized light to the mask board 58 causes variation in the amount of scattering of the orientation between the retardation regions 104. On the other hand, with the present embodiment, circularly polarized light is input to the mask board 58, and therefore the degradation amount becomes uniform among the retardation regions 60. Accordingly, the retardation plate 100 manufactured by inputting circularly polarized light into the mask board 58 has uniform amounts of scattering of the orientation among the retardation regions 104.

When using linearly polarized light, the mask board 58 is replaced according to the retardation region 60 with the most degradation, and therefore the mask board 58 has a short lifespan. In contrast, since circularly polarized light is input to the mask board 58 in the present embodiment, all of the retardation regions 60 of the mask board 58 degrade by substantially the same amount, thereby increasing the lifespan of the mask board 58.

With the present embodiment, the retardation regions 104 are formed on the film 90 with the same width as the retardation regions 60 of the mask board 58. In this way, by providing the retardation regions 104 of the manufactured retardation plate 100 with the retardation function of a quarter wavelength retardation plate, the manufactured retardation plate 100 can be used as a mask board 58.

With the present embodiment, the liquid crystal film 74 of the retardation mask 38 is arranged on the film 90 side on which the orientation film 120 is formed. In this way, the polarization state of the linearly polarized light modulated by the retardation region 60 including the liquid crystal film 74 is maintained, and this linearly polarized light irradiates the orientation film 120. In this way, the orientation film 120 is more suitably oriented.

The embodiment described above is an example in which the retardation plate 100 is manufactured while transporting the film 90, but instead, retardation plates 100 may be manufactured one at a time by exposing a film 90 having the same shape as a completed retardation plate 100 in a state where the orientation film 120 and the liquid crystal film 122 have been applied.

The following describes an experiment for verifying the effect of the embodiment described above. In this experiment, mask boards 58 were manufactured having five retardation regions 60 with optical axes oriented at 0°, 30°, 45°, 60°, and 90°, to serve as the test samples. Circularly polarized light and linearly polarized light having a polarization direction of 0° were input to these samples, and the degradation of these samples was investigated. The polarization direction of 0° is parallel to the optical axis of the retardation region 60 oriented at 0°.

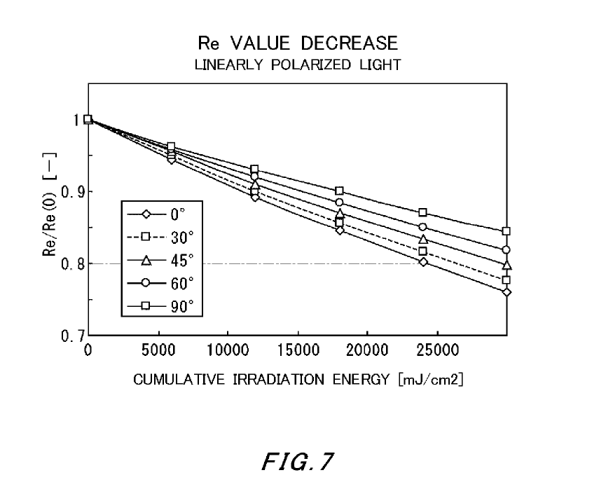

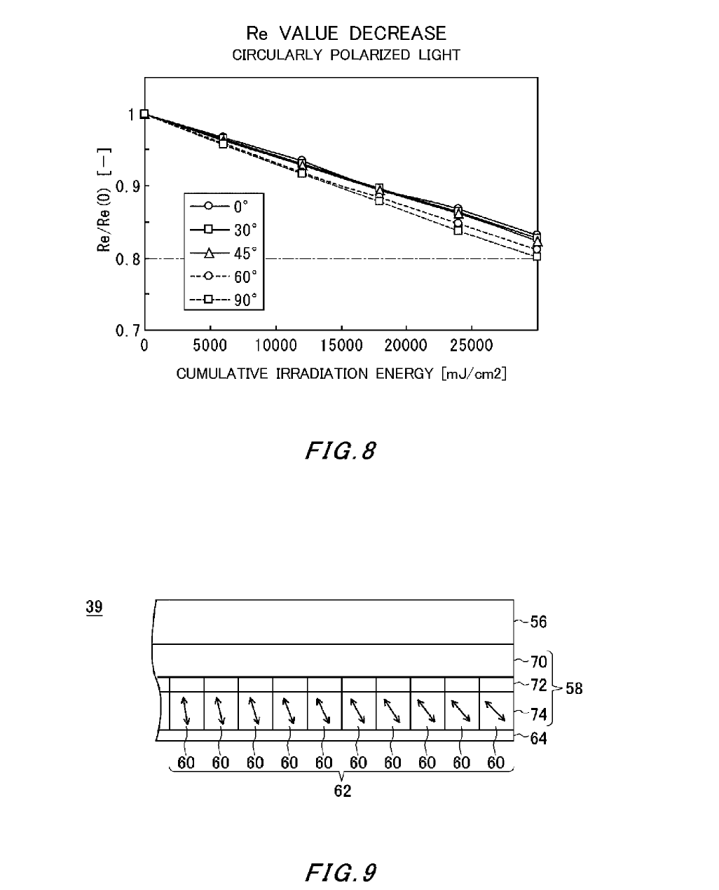

FIGS. 7 and 8 are graphs indicating the relationship between degradation of the mask boards 58 and cumulative irradiation energy. FIG. 7 shows experimental results when linearly polarized light having a polarization direction parallel to the 0° optical axis is input. FIG. 8 shows experimental results when circularly polarized light is input. Using the experimental results of FIGS. 7 and 8, change in the ratio of the phase difference relative to the phase different when input was begun is plotted with “1” representing the phase difference between the output polarized light and the polarized light input at the time when polarized light input is begun. The angles in FIGS. 7 and 8 indicate the angles of the optical axes of the retardation regions 60.

As shown in FIG. 7, when linearly polarized light is input, a large difference in degradation of the retardation regions 60 due to the different optical axes is seen. The retardation region 60 that has the 0° optical axis parallel to the polarization direction of the linearly polarized light degrades much more quickly than the retardation region 60 having the 90° polarization axis that is orthogonal to the polarization direction of the linearly polarized light. On the other hand, as shown in FIG. 8, when circularly polarized light is input, the difference in degradation among the retardation regions 60 is seen to be small. For example, in a case where the retardation ratio of “0.8” is set as a degradation determination reference, when the linearly polarized light is input, degradation is determined to have occurred and the mask board 58 must be replaced when the cumulative irradiation energy reaches approximately 24,000 mJ/cm². On the other hand, when the circularly polarized light is input, the determination that degradation has occurred is not made and the mask board 58 can be used until the cumulative irradiation energy reaches approximately 30,000 mJ/cm².

The following describes an embodiment in which the retardation mask 38 described above has been altered. FIG. 9 is a cross-sectional view of the altered retardation mask 39. As shown in FIG. 9, the retardation mask 39 further includes a protective film 64.

The protective film 64 is formed on the surface of the mask board 58 that is opposite the mask substrate 56. In other words, the protective film 64 is formed on the outer surface of the liquid crystal film of the mask board 58. The protective film 64 stops the oxidation of the retardation region 60 of the mask pattern 62. The protective film 64 is preferably a material that does not pass air. The protective film 64 can be formed by an anti-reflection film, an anti-glare film, or a barcode film, for example.

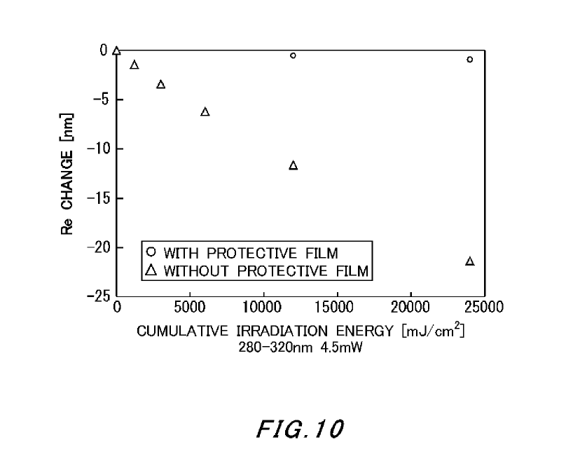

The following describes an experiment performed to verify the effect of the protective film 64 described above. FIG. 10 is a graph showing the relationship between degradation of the mask board 58 having the protective film 64 formed thereon and the cumulative irradiation energy. The protective film 64 was formed as an anti-reflection film. A mask board 58 without a protective film 64 was formed as a test sample used for comparison. These two types of mask boards 58 were both irradiated with ultraviolet light of 4.5 mW with a wavelength intensity peak from 280 nm to 320 nm.

As shown in FIG. 10, even when the cumulative irradiation energy reaches 24,000 mJ/cm², the mask board 58 with the protective film 64 formed thereon is seen to barely degrade. On the other hand, when the cumulative irradiation energy reaches 3,000 mJ/cm², the mask board 58 without the protective film 64 is clearly seen to degrade. In this way, the protective film 64 is seen to be able to protect the mask board 58.

The following describes the retardation mask 38 manufacturing method. The unoriented orientation film 72 having light orienting properties is applied on the resin substrate 70. The orientation film 72 is oriented by repeating a process that includes irradiating the unoriented orientation film 72 with linearly polarized light from a slit having the same width as a retardation region 60, shifting the slit by a distance equal to the width of a retardation region 60, and then irradiating the orientation film 72 with linearly polarized light having a different polarization direction. Furthermore, the liquid crystal film 74 is applied on the orientation film 72, and the liquid crystal film 74 is automatically oriented in alignment with the orientation of the orientation film 72 and cured. This retardation mask 38 may serve as a mother, to manufacture retardation masks 38 for retardation plates 100 according to the manufacturing method shown in FIGS. 3 to 6.

The embodiment described above is an example in which the retardation plate 100 includes a resin substrate 102 made of resin, but instead of this resin substrate 102, the retardation plate 100 may be provided with a glass substrate that supports the orientation film 120 and the liquid crystal film 122. When manufacturing this type of retardation plate 100, the orientation film 120 is not exposed during transport of the glass substrate. For example, in this case, the glass substrate is prepared to have the same shape as the finished product. Next, the orientation film 120 is applied on the glass substrate, and the orientation film 120 is exposed to become oriented. After this, the retardation plate 100 is manufactured by orienting the liquid crystal film 122 applied on the orientation film 120.

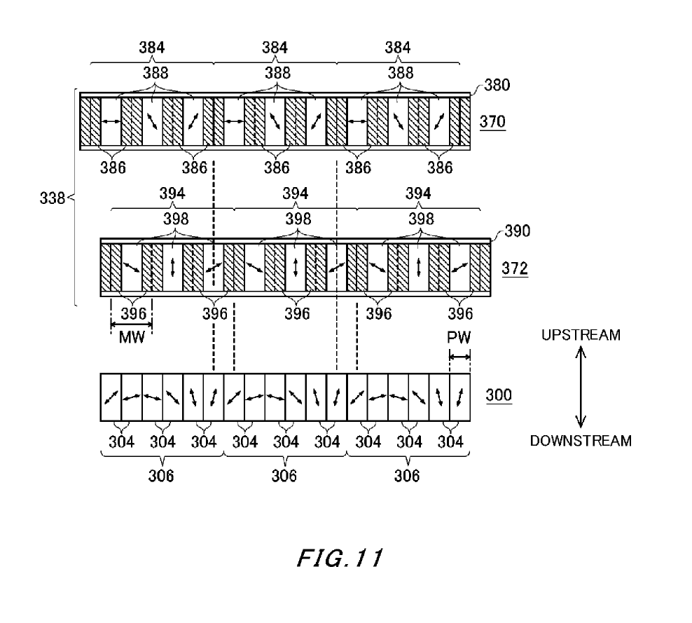

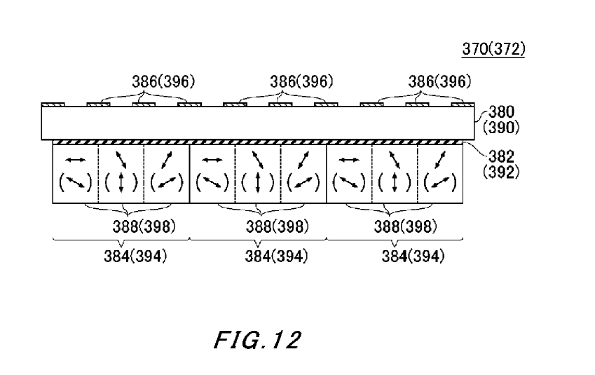

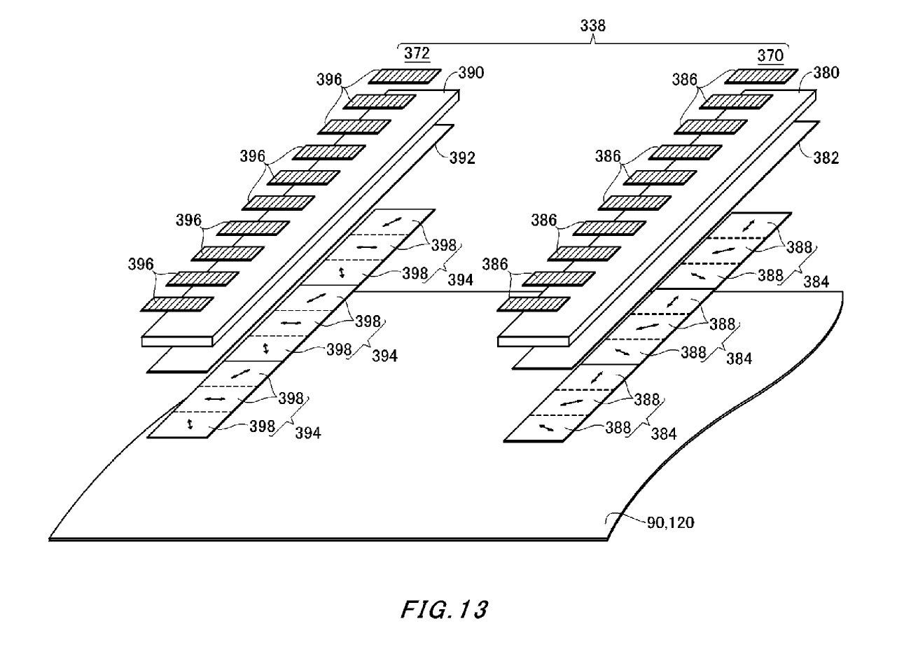

The following describes an embodiment obtained by altering a portion, specifically the mask, of the embodiment described above. FIG. 11 is a planar view for describing the orientation pattern 306 of the retardation plate 300 oriented by the altered retardation mask 338. The upstream and downstream directions shown in FIG. 11 are the upstream and downstream directions in the transport direction. FIG. 12 is a vertical cross-sectional view of he mask member 370 and the mask member 372 of the retardation mask 338. The reference numerals and optical axes shown in parentheses in FIG. 12 are the reference numerals and optical axes of the mask member 372. The optical axes in FIG. 12 are the optical axes as seen from a planar view. FIG. 13 shows the relationship between the film 90 and the exploded perspective view of the retardation mask 338. The retardation plate 300 manufactured according to the present embodiment has the same configuration as the retardation plate 100, aside from the orientation pattern 306 being different. In the retardation plate 300, the same orientation pattern 306 is repeated a plurality of times. The orientation pattern 306 has six retardation regions 304 that have optical axes oriented in different directions from each other.

As shown in FIGS. 11 to 13, the retardation mask 338 includes the mask member 370 and the mask member 372.

The mask member 370 includes a mask substrate 380, a refractive index adjusting layer 382, three mask patterns 384, and ten light blocking films 386. In FIG. 11, the hatched regions are the light blocking films 386.

The mask substrate 380 is made of a glass board that can pass light. The mask substrate 380 holds the mask patterns 384, and maintains the shapes of the mask patterns 384.

The refractive index adjusting layer 382 is provided at the border between the mask substrate 380 and the mask pattern 384. The refractive index of the refractive index adjusting layer 382 is preferably between the refractive index of the mask substrate 380 and the refractive index of the mask pattern 384. In this way, the refractive index adjusting layer 382 causes the change in refractive index at the border between the mask substrate 380 and the mask pattern 384 to be more gradual. As a result, the refractive index adjusting layer 382 reduces the amount of light reflected at the interface between the mask substrate 380 and the mask pattern 384, thereby restricting the interference caused by light reflected by the top surface of the mask substrate 380 and the border between the mask substrate 380 and the mask pattern 384. The refractive index adjusting layer 382 can use a regulator obtained by mixing an aromatic substance with a polyolefin type base oil, and may be made of Cargille refractive index liquid series A (refractive index range from 1.460 to 1.640), for example.

The mask patterns 384 are provided on the bottom surface of the mask substrate 380, with the refractive index adjusting layer 382 interposed therebetween. The three mask patterns 384 are arranged in the direction orthogonal to the transport direction. One edge of a mask pattern 384 is arranged to contact one edge of an adjacent mask pattern 384. The mask patterns 384 include three retardation regions 388 that correspond to a portion of the retardation regions 304 of the orientation pattern 306 of the retardation plate 300. The three retardation regions 388 are arranged in the direction orthogonal to the transport direction. The retardation regions 388 have a quarter-retardation function. Accordingly, when circularly polarized light is input, each retardation region 388 outputs linearly polarized light whose polarization direction is rotated by 45° relative to its own optical axis. The orientation directions of adjacent retardation regions 388 differ by 60°. The three mask patterns 384 each have the same orientation pattern. The width MW of the retardation regions 388 of the mask patterns 384 is double the width PW of the retardation regions 304 formed on the retardation plate 300 and the oriented film 90. This width MW need only be greater than the width PW. Here, the width of the mask pattern 384 and the width of the retardation regions 388 refer to length in the direction orthogonal to the transport direction. The mask patterns 384 each include an orientation film, a liquid crystal film, and a resin substrate, and have the same configuration as the retardation masks 38 and 39. The mask patterns 384 may omit the resin substrates, such that the orientation film and liquid crystal film are formed on the mask substrate 380 with the refractive index adjusting layer 382 interposed therebetween.

The ten light blocking films 386 are arranged on the top surface of the mask substrate 380. Specifically, the mask patterns 384 of the mask member 370 are arranged closer to the film 90 with the orientation film 120 applied thereto than the light blocking films 386. The ten light blocking films 386 are arranged in the direction orthogonal to the transport direction. The light blocking films 386 are formed on a boundary line between adjacent mask patterns 384, or on a boundary line between adjacent retardation regions 388 in each mask pattern 384. Specifically, the center of each light blocking film 386 is arranged on a boundary line between adjacent mask patterns 384 or on a boundary line between adjacent retardation regions 388 in each mask pattern 384. The width of each light blocking film 386 is half of the width MW of a retardation region 388 of the mask patterns 384. The interval between adjacent light blocking films 386 is the same as the width of a light blocking film 386. In other words, the retardation regions 388 of mask patterns 384 that are not covered by the light blocking films 386 have widths equal to the width PW of the retardation regions 304 of the film 90. The orientation film 120 applied on the film 90 is exposed and oriented by the retardation regions 388 in regions not covered by the light blocking films 386.

The mask member 372 is arranged at a position distanced from the mask member 370 in the transport direction. The mask member 372 and the mask member 370 are arranged in a manner to not overlap, when seen from a planar view. The mask member 372 is arranged at a position shifted by the width PW of the retardation region 388, in the direction orthogonal to the transport direction. The mask member 372 includes a mask substrate 390, a refractive index adjusting layer 392, three mask patterns 394, and ten light blocking films 396. The mask substrate 390, the refractive index adjusting layer 392, and the light blocking films 396 respectively have the same configuration as the mask substrate 380, the refractive index adjusting layer 382, and the light blocking films 386.

The mask patterns 394 each include three retardation regions 398. The orientation directions of the retardation regions 398 differ from the orientation directions of the retardation regions 388 of the mask patterns 384, but aside from this point the mask patterns 394 have the same configuration as the mask patterns 384. The retardation regions 398 of the mask patterns 394 are arranged at positions that do not overlap with the retardation regions 388 of the mask patterns 384, in the direction orthogonal to the transport direction. The orientation directions of the retardation regions 398 of the mask patterns 394 differ by 30° from the orientation directions of adjacent retardation regions 388 of the mask patterns 384, in the direction orthogonal to the transport direction. In this way, in the orientation film 120 applied on the film 90, the orientation directions of adjacent retardation regions 304 are sequentially rotated by 30°, as shown in the bottom portion of FIG. 11.

The following describes the method of manufacturing the retardation plate 300 using the retardation mask 338 described above. The retardation plate manufacturing apparatus of the present embodiment is the same as the retardation plate manufacturing apparatus 10, aside from the circularly polarized light modulating section 48 being omitted. As shown in FIG. 13, the mask member 372 and the mask member 370 of the retardation mask 338 are prepared and arranged. The mask member 370 is arranged upstream from the mask member 372. The exposed retardation regions 388 of the mask patterns 384 of the mask member 370 are arranged at positions differing from the positions of the exposed retardation regions 398 of the mask patterns 394 of the mask member 372, in the direction orthogonal to the transport direction.

Next, the unoriented orientation film 120 is applied to one surface of the film 90, and the film 90 is transported. In this state, the polarized light source 34 irradiates the retardation mask 338 with linearly polarized light. The orientation film 120 applied to the film 90 passing below the retardation mask 338 is oriented by being irradiated with the linearly polarized light emitted from the mask pattern 384 of the retardation mask 338. At this stage, the regions of the orientation film 120 passing under the regions where the light blocking films 386 of the mask member 370 are formed do not become oriented. Accordingly, the orientation film 120 is oriented in a manner to have intervals with the same widths as the light blocking films 386. After this the film 90 is transported farther, such that the orientation film 120 of the film 90 is oriented according to the mask pattern 394. In this way, the orientation film 120 is oriented in every region, without gaps remaining. Here, the regions of the orientation film 120 that pass under the boundary lines between mask patterns 384 of the mask member 370 are oriented by the mask patterns 394 of the mask member 372. Furthermore, the regions of the orientation films 120 passing under the boundary lines between the mask patterns 394 of the mask member 372 are oriented by the mask patterns 384 of the mask member 370. In this way, there are no remaining unoriented regions in orientation film 120 corresponding to the boundary lines between the mask patterns 384 and 394. After this, the liquid crystal film 122 is applied on the orientation film 120, to complete the retardation plate 300.

As described above, with the retardation plate 300 manufacturing method of the present embodiment, by arranging the plurality of mask patterns 384 and 394, the same orientation pattern 306 can be repeated to easily manufacture a retardation plate 300 that is long in the arrangement direction. As a result, although it has been difficult to manufacture a retardation plate that is long in the arrangement direction using the conventional manufacturing method that includes manufacturing the retardation plate with a single mask pattern, due to the need to remake the mask pattern, the manufacturing method of the present embodiment enables easy manufacturing of the retardation plate that is long in the arrangement direction.

Furthermore, with the present embodiment, the mask member 370 and the mask member 372 are arranged at different positions in the transport direction. In addition, the regions corresponding to the boundary lines between the mask patterns 384 of the mask member 370 are oriented by the mask patterns 394 of the mask member 372, and the regions corresponding to the boundary lines between the mask patterns 394 of the mask member 372 are oriented by the mask patterns 384 of the mask member 370. Therefore, the orientation film 120 can be prevented from remaining in an unoriented state in regions corresponding to the boundary lines between the mask patterns 384 and between the mask patterns 394. As a result, when adopting the retardation plate 300 manufactured according to the present embodiment in a diffraction grating of an optical low-pass filter, the light passed therethrough without being diffracted can be reduced.

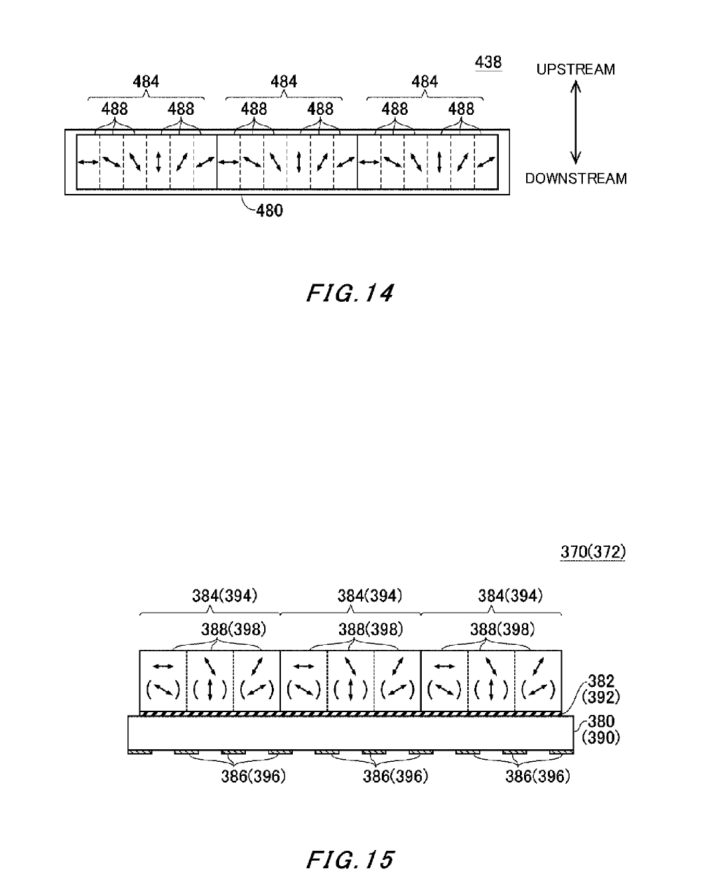

The following describes an embodiment in which the retardation mask 338 described above is altered. FIG. 14 is a planar view of the altered retardation mask 438. As shown in FIG. 14, the retardation mask 438 includes a mask substrate 480 and three mask boards 484. The mask substrate 480 has the same configuration as the mask substrate 380.

FIG. 15 is a view for describes an embodiment in which the mask members 370 and 372 are altered. FIGS. 11 to 13 show an example in which the light blocking films 386 are arranged higher than the mask members 370 and 372, but instead, the light blocking films 386 may be arranged lower than the mask members 370 and 372 in FIG. 15. In this case, the intervals between the light blocking films 386 is accurately reflected in the width of the retardation regions 304 of the retardation plate 300.

FIGS. 11 to 14 describe an example in which the retardation regions 388 and 398 have a quarter retardation function, but instead, the retardation regions 388 and 398 may have a half retardation function. In this case, the angles of the optical axes of the retardation regions 388 and 398 is different from those shown in FIG. 11. For example, the angles of the optical axes of the retardation regions 388 are at angles of 45°, 15°, and −15°, starting from the region at the leftmost end in FIG. 11. Furthermore, the angles of the optical axes of the retardation regions 398 are at angles of 30°, 0°, and 30°, starting from the region at the leftmost end. The angles of the optical axes are angles rotated counter-clockwise from 0°, which is the direction orthogonal to the transport direction. By inputting linearly polarized light with a polarization direction of 45° to these retardation regions 388 and 398, it is possible to manufacture a retardation plate 300 in which the optical axes of adjacent retardation regions 304 are rotated at uniform angular intervals.

The mask board 484 is provided on one surface of the mask substrate 480. The refractive index adjusting layer 382 described above is preferably provided between the mask board 484 and the mask substrate 480. Three mask boards 484 are arranged without gaps therebetween, in the direction orthogonal to the transport direction. The mask boards 484 each have six retardation regions 488. The retardation regions 488 have a half retardation function. The six retardation regions 488 have different optical axes from each other.

With the retardation mask 438 of the present embodiment, the retardation plate 300 that is long in the arrangement direction can be easily made, by adding the mask boards 484. Furthermore, in the present embodiment, the mask boards 484 are arranged in one line on the mask substrate 480, and therefore the combining of the mask board 484 with another mask board 484 during the exposure stage can be omitted.

The shapes, numerical values, materials, arrangements, and the like used in the configurations for each of the embodiments described above may be altered as desired. Furthermore, any of the above embodiments may be combined with each other.

For example, in the retardation mask 38 shown in FIG. 5, a plurality of the mask boards 58 with the mask pattern 62 formed thereon may be arranged. In this way, the embodiment shown in FIG. 5 can also be adapted for a wide film 90.

Furthermore, in the retardation mask 338 shown in FIGS. 11 to 13, each of the retardation regions 388 and 398 may have a quarter wavelength retardation plate function, and the retardation masks 338 may be irradiated with elliptically polarized light. In this way, partial degradation can also be prevented in the retardation mask 338.

In FIG. 5, the retardation mask 38 includes the mask substrate 56 and the resin substrate 70, but may instead include only one of these components. The retardation mask 38 may include identical optical axes within a single retardation region 60, and such retardation regions 60 may be arranged to continuously change the optical axes.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A retardation plate manufacturing method for manufacturing a retardation plate that has an orientation pattern in which is formed a plurality of regions having optical axes oriented in different directions from each other, the retardation plate manufacturing method comprising:
arranging an unoriented light orientation layer that is to be oriented by light on a first surface of a substrate;
preparing a retardation mask including an orientation pattern in which is formed a plurality of regions that have a quarter wavelength retardation plate retardation function and correspond to the plurality of regions in the orientation pattern of the retardation plate; and
orienting the light orientation layer by irradiating the retardation mask with elliptically polarized light and irradiating the light orientation layer with polarized light emitted form the retardation mask.

2. The retardation plate manufacturing method according to claim 1, wherein
width of the plurality of regions of the retardation mask is equal to width of the plurality of regions of the retardation plate.

3. The retardation plate manufacturing method according to claim 1, wherein
angle difference between optical axes of adjacent regions of the retardation mask is equal to angle difference between optical axes of adjacent regions of the retardation plate.

4. The retardation plate manufacturing method according to claim 1, wherein
the retardation mask includes a mask substrate that holds the orientation pattern,
the orientation pattern includes an orientation film, a liquid crystal film, and a substrate on which the orientation film is formed, and
the liquid crystal film is arranged on the light orientation layer side.

5. The retardation plate manufacturing method according to claim 1, wherein
a protective film that prevents oxidation of the orientation pattern of the retardation mask is formed on one surface of the orientation pattern of the retardation mask.

6. The retardation plate manufacturing method according to claim 1, wherein
the elliptically polarized light is ultraviolet light.

7. The retardation plate manufacturing method according to claim 1, wherein
the retardation mask has a configuration in which a plurality of the retardation plates, which each have the orientation pattern of the retardation mask formed thereon, are arranged.

8. A retardation plate manufacturing method for manufacturing a retardation plate that has repetitions of an orientation pattern in which is formed a plurality of regions having optical axes oriented in different directions from each other, the retardation plate manufacturing method comprising:
arranging an unoriented light orientation layer that is to be oriented by light on a first surface of a substrate;
preparing a retardation mask including a plurality of retardation plates that are arranged and each have an orientation pattern in which is formed a plurality of regions corresponding to at least a portion of the plurality of regions in the orientation patterns of the retardation plate; and
orienting the light orientation layer by irradiating the retardation mask with polarized light and irradiating the light orientation layer with polarized light emitted form the retardation mask.

9. The retardation plate manufacturing method according to claim 8, further comprising:
transporting the light orientation layer, wherein
the retardation mask includes a first mask member and a second mask member, in which a plurality of retardation plates having different orientation patterns formed thereon are arranged, and
the first mask member and the second mask member are arranged at different positions in a transport direction of the light orientation layer.

10. The retardation plate manufacturing method according to claim 9, wherein each region of the orientation patterns of the first mask member and the second mask member has greater width than each region of the orientation patterns of the retardation plate.

11. The retardation plate manufacturing method according to claim 10, wherein
light blocking films are formed at boundaries between the retardation plates of the first mask member and between the retardation plates of the second mask member, when viewed from a radiation direction of the polarized light.

12. The retardation plate manufacturing method according to claim 11, wherein
the orientation patterns of the first mask member and the second mask member are arranged closer to the light orientation layer than the light blocking films.
